(19) United States
(12) Patent Application Publication
(10) Pub. No.: US 2007/0039362 A1
(43) Pub. Date: Feb. 22, 2007

(54) Progressive digestion process for producing fertilizer

(76) Inventor: Dragan Mirkov Macura, Morgan Hill, CA (US)

Correspondence Address: Lorraine M. Donaldson, 2658 Del Mar Heights Road # 283, Del Mar, CA, 92014, US

(21) Appl. No.: 11/504,502

(22) Filed: Aug. 15, 2006

Related U.S. Application Data
(60) Provisional application No. 60/709,244, filed on Aug. 17, 2005.

(51) Int. Cl. C05D 9/02

(52) U.S. Cl. 71/1

(57) ABSTRACT

Progressive digestion process whereby organic matter is digested by optimizing, under controlled conditions, the natural digestive processes indigenous to any degrading organic material. The process follows a sequence of controlled mesophilic and thermophilic digestion steps such that each step facilitates the digestion of certain component of the incoming organic material. The last stage is carried out at a thermophilic temperature to inactivate any remaining vegetative cells of pathogenic microorganisms in the mixture. The resulting product is a dark, malodor and pathogen free, fully digested and shelf stable liquid organic fertilizer.

### PRIORITY CLAIMED

Applicant claims priority to a previous filed Provisional Patent Application Ser. No. 60/709,244, filed Aug. 17, 2005.

### BACKGROUND OF THE INVENTION

1. Field of the Invention

The invention relates to method of industrial production of fertilizer.

2. Description of Related Art

Previous methods for producing fertilizer commonly use organic inputs consisting of a single type of organic material, such as vegetable or animal matter. The organic input is stored in a container and may undergo a separation step to isolate the liquid or the solid in the input material and is allowed to ferment to produce a fertilizer containing certain nutrients, depending on the intended use of the fertilizer.

Examples of methods that do combine different organic input types when producing a fertilizer can be found in U.S. Pat. No. 6,464,875 of Woodruff and U.S. Pat. No. 6,273,927 of Yang. The method disclosed by Woodruff treats food, animal, vegetable byproducts, which are degradable anaerobically, through four primary stages, namely 1) an anaerobic digestion stage, 2) a liquid-solids separation stage, 3) an ammonia removal and recovery stage, and 4) a solids processing stage. The resulting solid product is dewatered and may be granulated or formed into pellets. Yang discloses a method of manufacturing a liquid fertilizer made from organic wastes such as food wastes, human excrements, animal excrements, slaughterhouse waste, henhouse waste, fish and shellfish wastes, vegetable wastes and agricultural wastes, wherein a combination of organic wastes, from those previously listed, are gathered according to the type thereof, crushed or mixed to be processed into good state for treating, and then the mixture is put into a treating tank and reacted by a natural digestant (lime, CaO), therefore, the toxicity of the organic wastes is neutralized; the organic wastes are sterilized; and the odor of the organic wastes is removed. Additional examples may be found in U.S. Pat. No. 5,782,950 of Kanitz et al. and U.S. Pat. No. 4,400,195 of Rijkens.

However, these methods process the mixture in a single digestion step failing to account for the different conditions for digesting each component which optimizes the resulting product.

The present invention presents a process in which the mixture undergoes a series of self-controlled, auto-thermal, mesophilic and thermophilic digestion steps designed to optimize the digestion of each component of the mixture thereby producing a fertilizer of predetermined characteristics.

Another benefit of the present invention is the capacity to reproduce a product of standard quality for industrial production of a shelf-stable, mal-odor and pathogen free, liquid fertilizer.

### BRIEF SUMMARY OF THE INVENTION

The present invention comprises, as illustrated in FIG. 1, a progressive digestion process (PDP) for producing fertilizer, comprising the steps of: receiving a mixture of organic input materials; blending said mixture; adjusting the pH value of said mixture; performing a controlled primary mesophilic digestion of said mixture; performing a controlled secondary mesophilic digestion of said mixture; performing a controlled thermophilic digestion of said mixture; centrifuging said mixture; filtering said mixture and storing the resulting filtered material; aerating the resulting filtered material for a predetermined period of time to thereby produce a fertilizer product of liquid, mal-odor and pathogen free and shelf stable form.

### BRIEF DESCRIPTION OF THE DRAWINGS

The present invention is described in detail below with reference to the drawings in which:

FIG. 1 shows a flowchart of the method of the present invention.

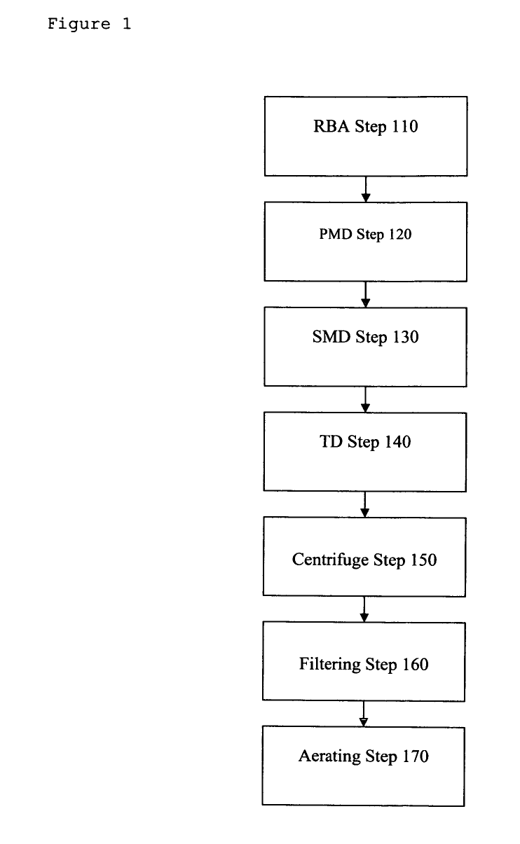

### DETAILED DESCRIPTION OF THE PREFERRED EMBODIMENTS

The following is a description of the progressive digestion process of the present invention.

The starting materials for the process form a mixture of organic inputs, including digestive enzyme source (DES) inputs, pH adjustment inputs and nutrient sources (NS).

Digestive enzyme source inputs may be waste materials such as fish processing wastes that contain fish and crab guts or other wasted animal digestive systems with all the unaltered digestive enzymes for animal-based proteins; malt barley plant wastes that carry digestive enzymes for starch-based NS inputs. Poultry slaughterhouse wastes with gizzard and poultry intestines carry enzymes for both plant and animal-based protein digestion. Rumen contents from sheep and beef slaughterhouses are good source of cellulytic microbes and enzymes that digest cellulose-containing plant materials such as wood chips and sawdust. Starch-digesting DES can be prepared by sprouting feed barley or other low-cost grains, grinding them, and adding to starch rich NS such as pasta or bakery wastes. The DES materials provide the digestive enzymes that augment the microbial digestion, the other major degradative process in PDP. It is important to match proper DES with the prevailing NS to facilitate complete digestion of waste organic inputs within the minimum length of time. After PDP is complete, the digestive enzymes from DES end up in soil where they contribute to additional organic matter degradation. This in turn contributes to the nutrient assimilation by the crops.

Examples of pH adjustment inputs are waste organic materials such as waste organic acids (citric, acetic, lactic, malic etc.) from their respective manufacturing plants. Or, they can be acidic wastes from operations such as juice extracting plants, fruit processing or resulting fruit waste. These materials are used to keep the pH of the fermentation down to reduce ammonia evaporation and foam creation during fermentation.

Nutrient source inputs vary in nutrient content according to the origin of the organic material. Thus, slaughterhouse wastes have more protein and bones than pasta processing plant wastes. By comparison, the pasta waste has more starch than slaughterhouse waste. Both are good PDP inputs since they both support good microbial growth and are easily digested. The microbial biomass also contributes to the overall nutrition (fertilizer value) of the final product, as the microbes also become plant food at the end of their life cycle.

The decision about the PDP organic inputs can be made on the basis of available organic wastes, or on the basis of the desired nutritional value of the final product. If it is made on the basis of available inputs, then the nutritional value of the final product is varied. If it is based on the nutritional value of the final product then the combination of the inputs varies with each change of the available supply.

This invention claims the unique combination of organic inputs and environmental conditions created by a succession of digestion vessels to obtain a completely digested, liquid, malodor and pathogen-free, fermented organic soil amendment (FOSA) or liquid organic fertilizer (LOF), and top soil dressing (TSD), that have been thermophilically treated for pathogen elimination and shelf stability.

Step 110—Receiving, Blending and Adjustments (RBA)

In Step 110, all starting materials are added to the RBA tank and re-circulated within the RBA tank. The RBA tank is strategically located to receive both liquid and ground solid materials such as slaughterhouse bones and hides, or animal carcasses from confined animal feeding operations (CAFO) mortalities. Solid materials are ground to less than 1 inch particle size.

After receiving a pre-determined amount of both liquid and solid inputs, the materials are re-circulated and ground to further reduce the particle size and homogenize the slurry in the RBA tank. A sample is taken at this stage to measure pH of the slurry. If needed, pH is adjusted by adding acidic wastes to reduce pH to less than 6. As soon as the material in RBA tank is easily pumpable, it is transferred to the primary mesophilic digester (PMD). Alternatively, the contents of RBA tank may be left undisturbed for 1 to 2 days to initiate enzymatic degradation under anaerobic conditions. Then, they are pumped to PMD.

Step 120—Primary Mesophilic Digestion (PMD)

During Step 120, the materials are mixed further and aerated. The liquid medium is constantly re-circulated by a pump on the tank. The speed of re-circulation pump is adjustable such that it causes gentle mixing inside the tank at its low speed setting, or a very vigorous mixing at the high end of the pump speed.

Oxygenated liquid medium is discharged at the bottom of the tank, thus experiencing maximum oxygen contact with liquid medium on its way out of the vessel, and thereby facilitating maximum oxygen dissolution. The liquid discharge into the vessel accomplishes both, the liquid mixing and oxygenation of the medium.

After the tank is filled with fresh material, the pump is turned on at a low speed until the fermentation starts to take hold as indicated by the temperature increase. Then, the pump is ramped up slowly until it reaches the maximum speed and maximum rate of aeration. Temperature, pH and oxidation-reduction potential (ORP) are monitored for process control. Also, the foam detector is turned on to monitor the foam level on the liquid surface. In addition, samples are taken for digestion analysis by monitoring the amount of free amino acids (Ninhydrin test) and undigested starch (Iodine test) in the medium. The insulation thickness on this tank is critical to holding the maximum temperature between 32 and 38° C. It is preferred to be at 36° C.

After the digestion has leveled off in PMD (2-5 days), the medium is pumped to the secondary mesophilic digester (SMD), for further processing.

Step 130—Secondary Mesophilic Digestion (SMD)

In step 130, the material coming from PMD is usually close to 38° C. It is a partially digested liquid. In SMD, it continues the digestion process, except the digestion takes place at a higher temperature. All other process parameter monitoring is the same as that in PMD. The final temperature reached in this vessel is between 45 and 50° C. The digestion is monitored throughout fermentation by taking samples daily and performing Ninhydrin and starch tests. After the digestion levels off, the SMD contents are pumped into the thermophilic digestion (TD) tank.

Step 140—Thermophilic Digestion (TD)

In step 140, the material coming from SMD is usually close to 50° C. It is even more digested than before it was moved to SMD. In TD tank the digestion continues. However, the maximum temperature reached in this tank exceeds 65° C. After moving the material from SMD tank, the pump on TD tank is ramped up slowly to raise the temperature to 65° C. over the next 2 days. It is kept at 65° C. for 3 days to assure pathogen elimination.

Other parameters monitored in this processing tank are ORP, pH, enzyme activity and microbial activity. It is important to monitor the microbial activity to make sure that viable microbial cells are in abundance in the final product. Enzyme activity in the final product shows what enzyme activity is added to the soil by adding fresh fermented fertilizer.

Final pH of the product is preferred to be less than 4.5 as this pH prevent proliferation of pathogenic microorganisms. However, after the heat treatment process, no unprocessed materials can be added due to the possibility of microbial contamination. Therefore, last pH adjustment in the process should be done in the SMD tank, before transfer to TD tank.

Step 150—Centrifugation

After thermophilic fermentation process is complete, the product is centrifuged in step 150 with a horizontal decanter centrifuge, or any appropriate solids separator. This assures solids separation and minimizes spray nozzle plugging in the spraying equipment. The liquid fraction after centrifugation constitutes LOF or FOSA, depending on its nutrient content, and the solids fraction constitutes TSD.

Step 160—Filtration

After the centrifugation step 160, the liquid product is passed through a vibrating screen to separate possible remaining light solids in the product and make it drip-tape compatible. Feed rate is monitored to assure proper filtration and maximum throughput. The product is poured into closed storage tanks outfitted with valves suitable for product recirculation.

Step 170—Aeration

In Step 170, the product is circulated and aerated in the storage tank for a predetermined period of time. The resulting product is in the form of a liquid, malodor and pathogen free and shelf stable fertilizer or soil amendment.

Moreover, PDP can also be used as a pathogen control process for treatment of wastes such as the segregated municipal food wastes, animal manures or sewage sludge. In this case, both the solid and the liquid fractions are thermophilically treated at the end of PDP. Solid fraction is a very good adjunct to the windrow composting piles, while the liquid fraction can be used as a soil amendment, or as a stock for higher nutritional value fertilizer by adding more organic nutrients and repeating PDP.

While the present invention has been shown and described herein in what are conceived to be the most practical and preferred embodiments, it is recognized that departures, modifications, adaptations, variations and alterations in the described method may be made and will be apparent to those skilled in the art of the foregoing description which does not depart from the spirit and scope of the invention which is therefore not to be limited to the details herein.

For this reason, such changes are desired to be included within the scope of the appended claims. The descriptive manner which is employed for setting forth the embodiments should be interpreted as illustrative but not limitative of the full scope of the claims which embrace any and all equivalents thereto.

What is claimed is:

1. A progressive digestion process for producing fertilizer, comprising the steps of:
receiving a mixture of organic input materials;
blending said mixture;
adjusting the pH value of said mixture;
performing a controlled primary mesophilic digestion of said mixture;
performing a controlled secondary mesophilic digestion of said mixture;
performing a controlled thermophilic digestion of said mixture;
centrifuging said mixture, or otherwise separating solids;
filtering said mixture and storing the resulting filtered liquid;
aerating the resulting filtered liquid for a predetermined period of time to thereby produce a fertilizer product of liquid, mal-odor and pathogen free and shelf stable form.

2. A progressive digestion process for producing fertilizer, comprising the steps of:
receiving a mixture of organic input materials in a first tank;
re-circulating said mixture within said first tank;
adjusting a pH value of said mixture to a predetermined pH value;
transferring said mixture to a second tank for primary mesophilic digestion, including:
re-circulating said mixture within said second tank until fermentation begins as indicated by a temperature increase, wherein during this step the mixture temperature and at least one other physical parameters of said mixture is monitored to determine when the mixture temperature has reached a first predetermined maximum value; and
controlling said step of re-circulating the mixture within the second tank to maintain the mixture temperature at said first predetermined maximum value for a predetermined period of time;
transferring said mixture into a vessel for secondary mesophilic digestion, wherein said step includes monitoring said mixture temperature and said at least one other physical parameters of said mixture to monitor the fermentation process until the mixture temperature reaches a second predetermined maximum value;
transferring said mixture into a third tank for thermophilic digestion, including:
re-circulating said mixture, wherein said step includes monitoring said mixture temperature and said at least one other physical parameters of said mixture to monitor the fermentation process until the mixture temperature reaches a third predetermined maximum value; and
controlling said step of re-circulating the mixture of within said third tank to maintain the mixture temperature at said third value for a predetermined period of time;
performing a step of centrifugation on said mixture;
performing a step of filtering said mixture and storing a resulting filtered material; and aerating said resulting filtered material during a predetermined period of time for a resulting fertilizer product in liquid, malodor and pathogen free and shelf stable form.

3. The process of claim 2, wherein said mixture of organic input materials comprises at least one of the group consisting of animal manures, food industry wastes, sorted municipal food wastes, vegetable processing leftovers, grass clippings and combinations thereof.

4. The process of claim 2, wherein said predetermined pH value is less than 6.

5. The process of claim 2, wherein said at least one other physical parameter monitored during said step of primary mesophilic digestion is one of the group consisting of pH value, oxidation-reduction potential, foam level.

6. The process of claim 2, wherein said at least one other physical parameter monitored during said step of primary mesophilic digestion comprises pH value, oxidation-reduction potential and foam level.

7. The process of claim 5, wherein said step of primary mesophilic digestion further comprises sampling said mixture to determine an amount of free amino acids and an amount of undigested starch.

8. The process of claim 2, wherein said step of secondary mesophilic digestion further comprises the step of sampling said mixture to determine an amount of free amino acids and an amount of undigested starch.

9. The process of claim 2, wherein said step of secondary mesophilic digestion of said mixture further comprises a second step of adjusting the pH value of the mixture.

10. The process of claim 2, wherein said at least one other parameter monitored during said step of thermophilic digestion comprises one of the group consisting of oxidation-reduction potential, pH value, enzyme activity, microbial activity, and combinations thereof.

11. The process of claim 2, wherein said at least one other parameter monitored during said step of thermophilic digestion comprises oxidation-reduction potential, pH value, enzyme activity, and microbial activity.

12. The process of claim 2, wherein the first predetermined maximum temperature value is 38° C.

13. The process of claim 2, wherein said second predetermined maximum temperature value is 50° C.

14. The process of claim 2, wherein said third predetermined maximum temperature value is 65° C.
